(19) United States
(12) Patent Application Publication
(10) Pub. No.: US 2025/0373716 A1
(43) Pub. Date: Dec. 4, 2025

(54) STORAGE ACCESSORY FOR A PHONE COVER

(71) Applicant: Jayden Gracie, Nashville, TN (US)

(72) Inventor: Jayden Gracie, Nashville, TN (US)

(21) Appl. No.: 18/982,159

(22) Filed: Dec. 16, 2024

Related U.S. Application Data
(60) Provisional application No. 63/652,387, filed on May 28, 2024.

(51) Int. Cl. H04M 1/02; A45C 11/16

(52) U.S. Cl. CPC H04M 1/0203; A45C 11/16

(57) ABSTRACT

A storage accessory for a phone cover that may be used to store at least a jewelry ring. The storage accessory includes a pouch for storing cards and currency. The storage accessory includes a storage compartment configured on the pouch, wherein the storage compartment has a sidewall defining an inner volume of the storage compartment, an open front, and a cap covering the open front. The cap includes locks for securing the cap to the storage compartment. The storage compartment includes a conical member and an anchor extending from a tip of the conical member.

### CROSS-REFERENCE TO RELATED APPLICATIONS

This application claims priority from a U.S. Provisional Patent Appl. No. 63/652,387, filed on May 28, 2024, which is incorporated herein by reference in its entirety.

### FIELD OF INVENTION

The present invention relates to a phone case, a storage accessory for a phone case, and a method for storing an article relative to a phone case.

### BACKGROUND

Misplacing small items such as keys and jewelry is common in daily life. One example of this is the wedding ring. For instance, to protect the rings when doing household chores or work, the rings are often taken off from fingers and kept here and there. For example, the rings may get damaged by soap while taking a bath. Also, loose rings easily slip off and are lost when doing certain chores. However, keeping the rings here and there often results in misplacing the rings as the people may forget the place where the ring was kept. Although jewelry boxes are typically used to store these items, they are not always accessible.

The loss of an item, such as jewelry, leads to a financial setback. However, losing a wedding ring has a significant emotional impact. Wedding rings symbolize a commitment to a partner and hold immense emotional value. The wedding rings are traditionally worn daily, and there is a strong emotional attachment to them. While it is desired to wear the ring regularly, there are times when it needs to be removed for certain tasks. A person must be diligent about safely storing the ring, as carelessness can lead to loss or damage. However, some laziness in safely storing the ring is common resulting in the waste of time in finding the ring, and often losing the ring.

A need is therefore appreciated for a storage accessory that is readily accessible to a user for storing small articles, especially a ring.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is directed to a storage accessory for a phone case.

Another object of the present invention is that at least one or two rings can be safely and securely kept in the storage accessory.

Still another object of the present invention is that the storage accessory is easy to access.

A further object of the present invention is that the storage accessory is available to the user readily most of the time.

Still, a further object of the present invention is that the storage accessory is economical.

A further object of the present invention is that the storage accessory can be used with a phone cover.

Still, a further object of the present invention is that the storage accessory can be retrofitted to a phone cover.

An additional object of the present invention is that the storage accessory can be used to store other things, such as currency notes and credit cards.

Still, an additional object of the present invention is that the storage environment can be isolated from the external environment.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a front view of a storage accessory for a phone case, according to an exemplary embodiment of the present invention.

FIG. 2 is a side view of the storage accessory with a phone case, according to an exemplary embodiment of the present invention.

FIG. 3 shows an inner view of the phone case, according to an exemplary embodiment of the present invention.

FIG. 4 shows another side view of the storage accessory with the phone case, according to an exemplary embodiment of the present invention.

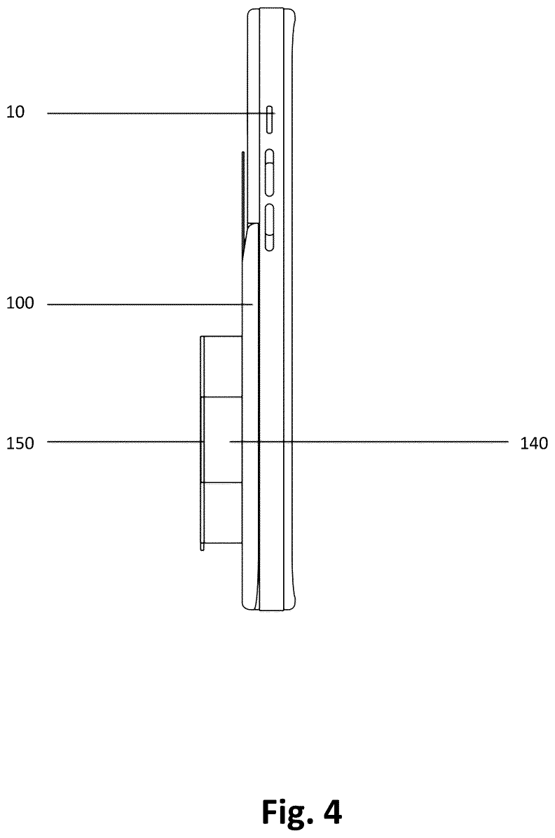

FIG. 5 shows a side view of the storage accessory, according to an exemplary embodiment of the present invention.

FIG. 6 shows a rear view of the storage accessory, according to an exemplary embodiment of the present invention.

FIG. 7 shows another side view of the storage accessory, according to an exemplary embodiment of the present invention.

FIG. 8 shows a top view of the storage accessory, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The invention described herein pertains to a storage accessory for storing small articles, such as rings. The storage accessory can be coupled to a phone case so that the storage accessory can be used with a phone. Nowadays, people rarely go anywhere without their phones. Also, there is a tendency to keep a phone closer, so that it is readily accessible to the user. For example, the phone is kept nearby so that a person hears any notification and can attend to the phone. Thus, a storage accessory coupled with the phone will also be readily available to the user. Moreover, most phones have GPS tracking features making them easy to locate if misplaced.

Disclosed is a storage accessory that can be attached to a phone cover. Also disclosed is a phone case with a storage accessory. The storage accessory can be used to store small articles, especially a ring. The storage accessory can also be used to store currency notes and credit cards. Multiple utility of the disclosed storage accessory makes it versatile and more useful to the user. The user can also carry cash and credit cards with the phone. The storage accessory can keep the ring safe and secure while readily accessible.

A person while performing daily chores can take the ring off from their finger and place the same in the disclosed storage accessory. For example, the person may keep his phone in a pocket or a purse, and could easily and quickly take out the phone, and keep the ring in the disclosed storage accessory attached to the phone case of the phone. It is to be noted that exemplary embodiments describe attaching the disclosed accessory to a phone case, however, it is to be noted that the disclosed accessory can be attached to the phone body as well. Moreover, the disclosed storage accessory can also be attached to any suitable structure.

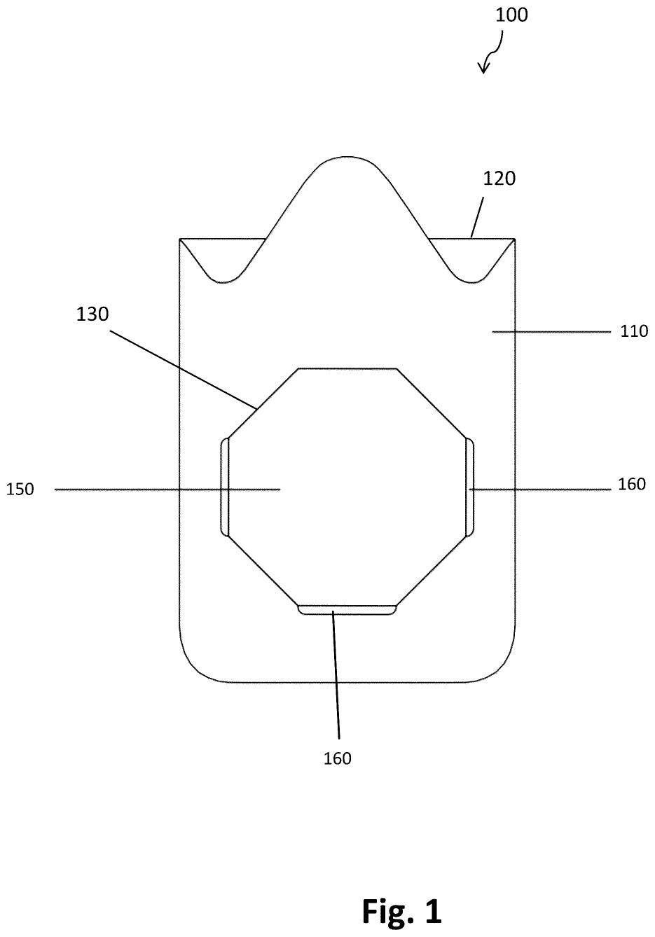

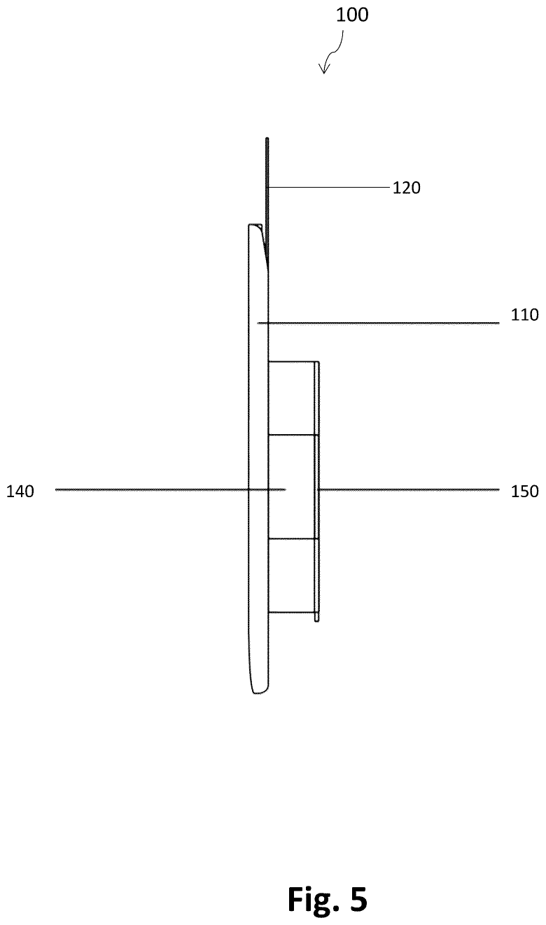

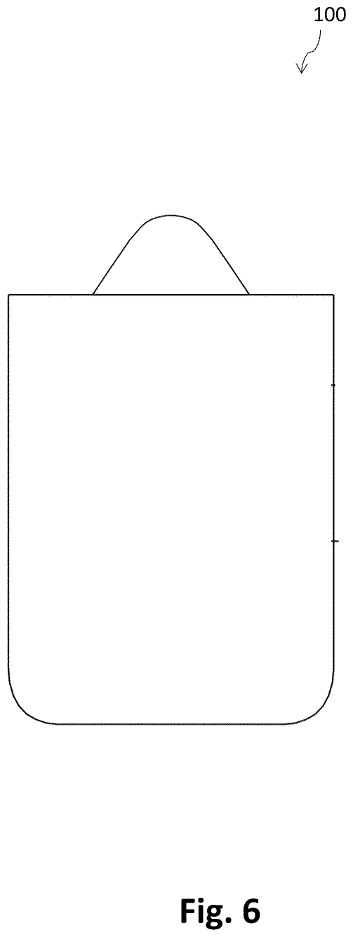

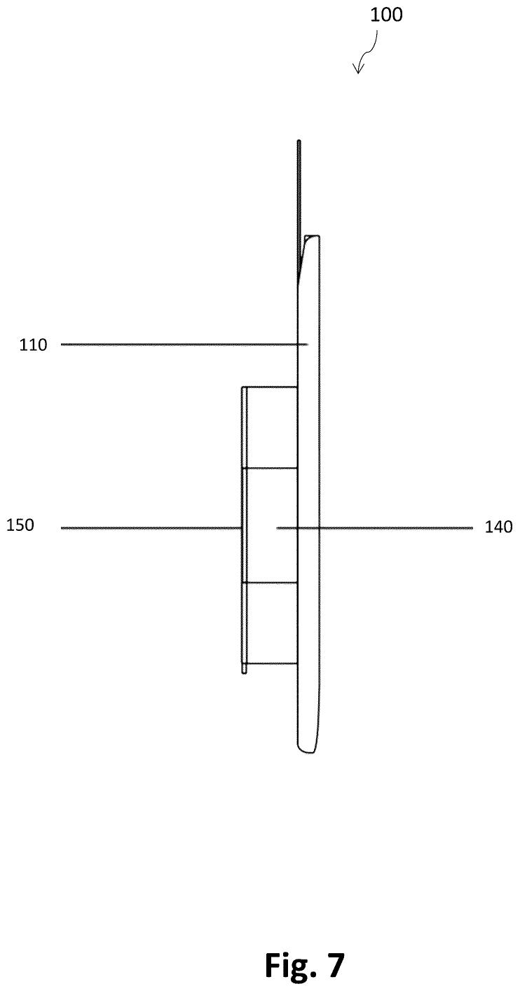

Referring to the drawings, FIG. 1 shows a front view of the storage accessory, FIG. 5 shows a left-side view of the storage accessory, FIG. 6 shows a rear view of the storage accessory, FIG. 7 shows a right-side view of the storage accessory, and FIG. 9 shows a top view of the storage accessory. The storage accessory 100 includes a front panel 110 and a rear panel 120 which forms a pouch that can be used to store planar articles, such as currency notes and credit cards. On the rear face of the rear panel can be applied a layer of adhesive. The storage accessory at the layer of adhesive can be adhered to the phone cover. It is to be noted that any other means of attaching the storage accessory to any supporting structure is within the scope of the present invention.

A storage compartment 130 can be configured in the front panel of the storage accessory. The storage compartment can be in the form of a box having an inner volume. The storage compartment can have a rear wall and side walls 140 defining the inner volume of the storage compartment. The rear wall can be attached or integrated into the front panel. The front panel itself can form the rear wall of the storage compartment. The storage compartment can be opened at the front allowing from accessing the inner volume of the storage compartment 120. The ring can be placed inside the compartment through the open front.

The open front of the storage compartment can be closed by a cap 150. The cap, also referred to as a lid, can close the open front of the storage compartment. The cap may be secured to the storage compartment through one or more locks. The cap can be removed to gain access to the interior of the compartment. The cap can somewhat sealably secure the open front so that the ingress of contamination or moisture into the compartment can be prevented.

The cap can be secured to the storage compartment using a suitable lock. The lock may prevent accidental opening of the cap, for example, when the phone is in a pocket. The drawings show the cap having three locks 160 that allow securing the cap to the storage compartment. The cap can be of a planar profile. The drawings show the cap is octagonal i.e., having eight sides. Two locks can be provided on the left and right sides of the cap. A third lock can be provided on a bottom side of the cap. The locks can snap fit over the edges of the side walls of the storage compartment. The exposed edges of the sidewall may have a lining, and the locks can snap fit over the lining to secure the lock. Each lock may have a tab that has to be pressed inwards to pass the lock across the lining. Thus, to secure the cap or remove the cap, the tab of the lock must be pressed allowing the lock to pass over the protruding lining. It is to be understood that lining may be continuous or discontinuous.

To remove the cap, the three locks must be operated together. This may be an essential feature that prevents the accidental removal of the cap. To remove the cap, a user can use two fingers and a thumb together to press the tabs of the three locks and pull the cap outwards. Also, instead of the two fingers and the thumb, three fingers can be used in synchronization to unlock the three locks and remove the cap.

It is to be understood, that the above-described locking mechanism is an exemplary illustration; however, any locking mechanism can be incorporated for securing the cap, and any such mechanism is within the scope of the present invention. For example, instead of tabs, buttons can be provided for releasing the cap. The user can first press the two buttons and then the third button to release the cap.

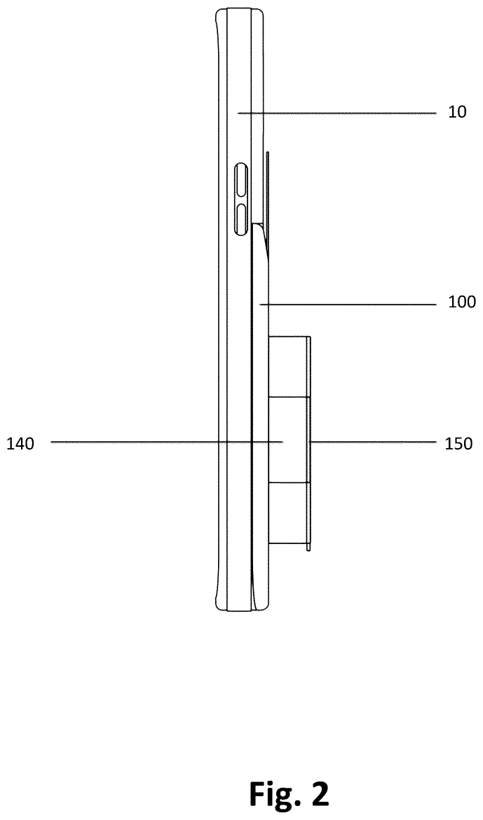

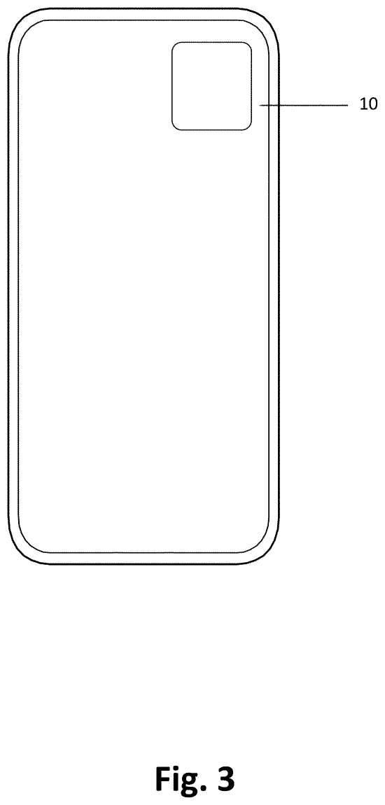

In certain implementations, the cap can be attached to the storage compartment through a teether to prevent misplacing of the cap. It is to be noted that the cap can be secured to a wall of the compartment using any other suitable mechanism, such as a lanyard, and any such mechanism is within the scope of the present invention. FIG. 2 shows the accessory 100 coupled with a phone case 10. FIG. 3 shows the front side of the phone cover 10 that can receive a phone.

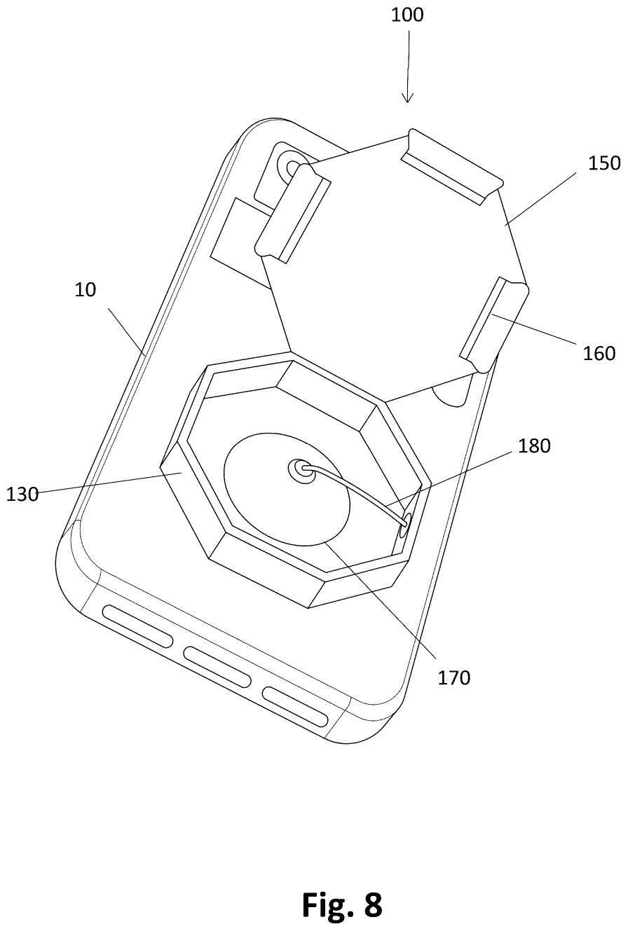

Referring to FIG. 8 which shows the interior volume of the storage compartment. The cap is shown in the open state. As shown in the drawing, three sides have locks, while the fourth side is coupled to a side wall of the storage compartment through a hinge joint. The storage compartment may include a conical member 170 positioned at the center of the storage compartment. The broad side of the conical member can be coupled to the rear wall of the storage compartment. It is to be understood that the end of the conical member may or may not be pointed out. For example, the conical member may be of a frusto-conical shape. The lower portion of the conical member can have a diameter larger than the inner diameter of the ring. The ring can be mounted over the conical member, and rest over the lower portion of the conical member. The ring may be snugly fit over the lower portion of the lower portion of the ring member. This may prevent the ring from jiggling inside the compartment.

The conical member may also include an anchor 180 extending from the tip of the conical member. The anchor can provide additional security measures for the ring. After mounting the ring over the conical member, the anchor can be engaged to prevent the ring from coming out of the conical member. In certain implementations, the anchor can be in the form of a semi-rigid cord extending from the tip of the conical member. The end of the cord may have a magnet, bead, or hook. The magnet or hook can be attached to the side wall of the compartment.

In certain implementations, the side wall of the compartment may not be rigid but could be pleated, allowing the side walls to collapse and extend. The compartment can be compressed at the cap resulting in the collapsing of the side walls, reducing the depth of the compartment. This not only decreases the bulkiness of the compartment according to the size of the article to be stored in the compartment but also secures the article. For example, scrounging the side walls can provide ideal depth for holding a ring preventing any ring movement.

In certain implementations, the disclosed storage accessory, also referred to herein as an apparatus, may hold jewelry such as wedding rings. The disclosed storage accessory may provide a convenient, safe, and waterproof way to store a ring on the go. To store the ring, the cover or cap of the storage accessory can be opened, and the anchor can be lifted. Thereafter, the ring can be placed over the conical member. The ring may slide down until it meets resistance based on the size of the ring relative to the conical member. Optionally, the ring may be pressed over the conical member to freeze it in place and minimize jiggling. Thereafter, the anchor may be engaged i.e., the cord may be made to bent sidewards with some force. Then the cap can be closed by pressing the cap over the storage compartment. To make the extension less bulky and further prohibit ring movement within the compartment, users can scrunch down the sides of the compartment to make it the ideal depth for holding the ring. The design ensures that rings are securely stored on the back of the phone, offering a portable and trackable storage solution for occasions when ring removal is necessary.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A storage accessory comprising:
a front panel;
a rear panel, wherein the front panel and the rear panel form a pouch; and
a storage compartment configured on the front panel, the storage compartment has a sidewall defining an inner volume of the storage compartment.

2. The storage accessory of claim 1, wherein a rear face of the rear panel has a layer of adhesive.

3. The storage accessory of claim 2, wherein the storage compartment comprises sidewalls, the storage compartment has an open front, and the open front is covered by a cap,

4. The storage accessory of claim 3, wherein the cap comprises one or more locks for securing the cap to the storage compartment.

5. The storage accessory of claim 4, wherein the storage accessory further comprises:
a conical member mounted within the storage compartment.

6. The storage accessory of claim 5, wherein the storage accessory further comprises:
an anchor extending from a tip of the conical member.

7. A phone cover comprising:
a storage accessory comprising:
a front panel;
a rear panel, wherein the front panel and the rear panel form a pouch; and
a storage compartment configured on the front panel, wherein the storage compartment has a sidewall defining an inner volume of the storage compartment.

8. The phone cover of claim 7, wherein a rear face of the rear panel is attached to a rear face of the phone cover.

9. The phone cover of claim 8, wherein the storage compartment comprises sidewalls, the storage compartment has an open front, and the open front is covered by a cap,

10. The phone cover of claim 9, wherein the cap comprises one or more locks for securing the cap to the storage compartment.

11. The phone cover of claim 10, wherein the storage accessory further comprises:
a conical member mounted within the storage compartment.

12. The phone cover of claim 11, wherein the storage accessory further comprises:
an anchor extending from a tip of the conical member.

13. A method for storing a ring, the method comprises:
attaching a storage accessory to a phone cover, the storage accessory comprises:
a front panel;
a rear panel, wherein the front panel and the rear panel form a pouch; and
a storage compartment configured on the front panel, the storage compartment has a sidewall defining an inner volume of the storage compartment; and
storing the ring in the storage accessory.

14. The method of claim 13, wherein a rear face of the rear panel has a layer of adhesive.

15. The method of claim 14, wherein the storage compartment comprises sidewalls, the storage compartment has an open front, and the open front is covered by a cap,

16. The method of claim 15, wherein the cap comprises one or more locks for securing the cap to the storage compartment.

17. The method of claim 16, wherein the storage accessory further comprises:
a conical member mounted within the storage compartment.

18. The method of claim 17, wherein the storage accessory further comprises:
an anchor extending from a tip of the conical member.
